(19) United States
(12) Patent Application Publication
(10) Pub. No.: US 2011/0079323 A1
(43) Pub. Date: Apr. 7, 2011

(54) Wood Splitting Apparatus

(76) Inventor: Kevin J. Green, Blissfield, MI (US)

(21) Appl. No.: 12/753,576

(22) Filed: Apr. 2, 2010

Related U.S. Application Data
(60) Provisional application No. 61/166,147, filed on Apr. 2, 2009.

(51) Int. Cl. B27L 7/06

(52) U.S. Cl. 144/195.8

(57) ABSTRACT

A wood splitting apparatus having a splitting wedge mounted to a frame. The wedge configured to have multiple cutting edges that engage the workpiece. The apparatus further including a lift mechanism for transferring a workpiece to a workpiece carriage area adjacent the splitting wedge. The lift mechanism is pivotally connected to the frame whereby actuation of a power cylinder moves the lift mechanism from an initial position where a workpiece is loaded onto the lift mechanism and a second position wherein the workpiece is deposited from the lift mechanism into the workpiece carriage area.

### CROSS-REFERENCE TO RELATED APPLICATIONS

This application claims the benefit of U.S. Provisional Application No. 61/166,147, filed Apr. 2, 2009.

### BACKGROUND OF THE INVENTION

1. Field of the Invention

The present invention relates to an apparatus for splitting wood; and more specifically, to a log splitter utilizing a power driven ram that forces a piece of word into a splitting wedge.

2. Description of Related Art

Reducing logs into useable sized firewood has been done for centuries. Since the early to mid 1900s, pneumatics and hydraulics have been used to forcibly push a log into and through a splitting wedge. In today's modern era hydraulics are used almost exclusively.

In the firewood industry logs are cut to firewood length, typically 18″ to 24″ long and then split into sections. Typically, once cut to firewood length, the logs are placed onto the log carriage of a wood splitter. The log carriage is the area between a splitting wedge and a log pusher. The log pusher is an apparatus, typically a flat plate, located at the end of a hydraulic cylinder. Actuation of the hydraulic cylinder drives the log through the splitting wedge that splits or separates the log in half.

To date most splitting wedges are similar to the one shown in U.S. Pat. No. 7,334,615 to Paradise. The wedge has a straight, flat vertical face and is mounted vertically on top of the log carriage at a 90-degree angle to the log carriage. When the log is pushed against this straight, flat face of the splitting wedge the full cutting surface of the wedge comes into contact with the log. Pressure builds up behind the log until the log is forced to split all at once. Forcing a log through a splitting wedge all at once is inefficient because it requires a large amount of energy.

However, not all splitting wedges are straight and vertically oriented. U.S. Pat. Nos. D552,133 and 7,255,143 to Babcock et al. disclose a log splitting wedge having a radiused splitting wedge with structures on the end of the wedges that help contain the log during splitting operations. This wedge splits wood from the center of the wedge out to the top and the bottom of the wedge. U.S. Pat. No. 4,782,866 to Valdez shows a wedge with a sloped top and bottom portion having sharpened leading edges and made in a V-shape.

### SUMMARY OF THE INVENTION

The present invention relates to a wood splitting apparatus including a frame with a wedge supported on the frame. A drive mechanism is further supported on the frame and is operative to drive a log or chunk of wood into the wedge to split the wood. A lift mechanism is further attached to the frame with the lift mechanism operative to lift and deposit any log or chunk of wood in a log carriage area located between the drive mechanism and the wedge.

Another aspect of the invention includes the wedge having a multi-angle cutting edge wherein at least one of the cutting edges gradually tapers or angles backward, that is away from the drive mechanism.

A further aspect of the invention includes a front support member that can be selectively positioned to level the front end of the apparatus.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a wood splitting apparatus according to the present invention;

FIG. 2 is a partial perspective view of the wedge assembly of the wood splitting apparatus of FIG. 1;

FIG. 3 is a partial perspective view of the cradle portion and support member of the wood splitting apparatus of FIG. 1;

FIG. 4 is another partial perspective view of the cradle portion and support member of the wood splitting apparatus of FIG. 1;

FIG. 5 is a side perspective view of a lift mechanism of the wood splitting apparatus of FIG. 1 shown removed therefrom;

FIG. 6 is a rear perspective view of the lift mechanism of FIG. 5 of the wood splitting apparatus of FIG. 1;

FIG. 7 is a side perspective view of a lift mechanism of FIG. 5 illustrating the lift mechanism in an extended position; and

FIG. 8 is a side perspective view of a log pusher assembly of the wood splitting apparatus of FIG. 1.

### DETAILED DESCRIPTION OF THE PREFERRED EMBODIMENTS

The following description of the preferred embodiment(s) is merely exemplary in nature and is in no way intended to limit the invention, its application, or uses.

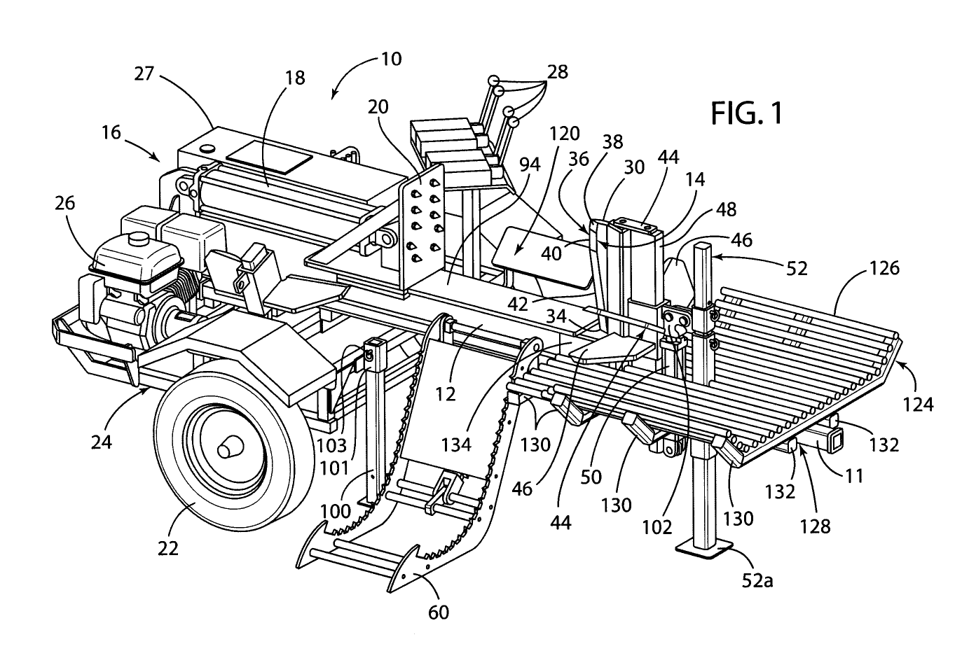

FIG. 1 illustrates a wood splitting apparatus, seen generally at 10, according to the present invention. The apparatus is a trailer-type wood splitting apparatus 10 that can be coupled to a transport vehicle using a hitch tube 11. Accordingly, while shown as a transportable wood splitting apparatus 10, it should be understood that the apparatus 10 could also be stationary. Further, the term workpiece as used herein refers generally to a log or chunk of wood. To the extent the device or aspects thereof can be used with workpieces other than a log or chunk of wood, the terms should not be construed as limiting the scope of the invention.

The apparatus 10 includes an elongated member 12 generally formed of a beam having an I or H cross-section or configuration. The elongated member 12 forms a portion of the frame of the apparatus 10. A wedge, seen generally at 14, is located at one end of the elongated member 12 and a drive mechanism, seen generally at 16, is located at the other end of the elongated member 12. The drive mechanism 16 generally includes a hydraulic cylinder 18 attached to a log pusher 20, whereby actuation of the hydraulic cylinder 18 moves the log pusher 20 back and forth in the direction of the longitudinal axis of the elongated member 12. During operation, a workpiece is placed in the log carriage area 120, that is the area between the log pusher 20 and the wedge 12, whereby actuation of the hydraulic cylinder 18 drives the log pusher 20 which correspondingly forces the workpiece against the wedge 14 to split the workpiece.

The apparatus 10 further includes a pair of wheels 22 attached to a multimember frame, seen generally at 24. The multimember frame 24 is connected to and supports one end of the elongated member 12. As set forth in greater detail below, the opposite end of the elongated member 12 is supported by a front support member 52. The multimember frame 24 further supports a power source, such as a gasoline powered engine 26, that operates to provide power, through a hydraulic pump and hydraulic fluid reservoir assembly 27, to the various hydraulic cylinders used in conjunction with the apparatus 10. A plurality of actuation or operating levers 28 function to control the hydraulics and correspondingly the operation of the log splitter 10. As known in the art, the actuation or operating levers 28 control the flow of hydraulic fluid from the hydraulic pump through hydraulic hoses coupling the hydraulic pump to the hydraulic cylinders, 18, 50, 84, 86 located on the apparatus 10.

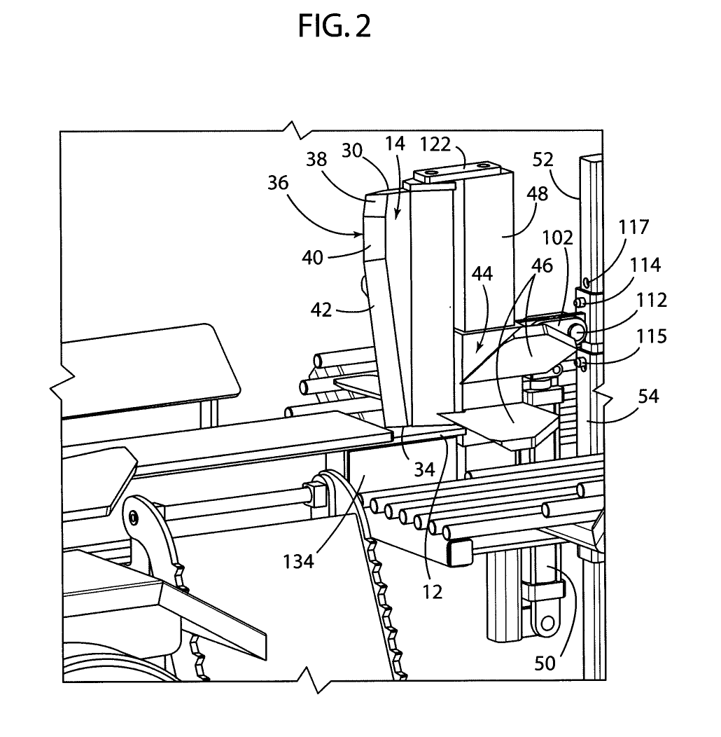

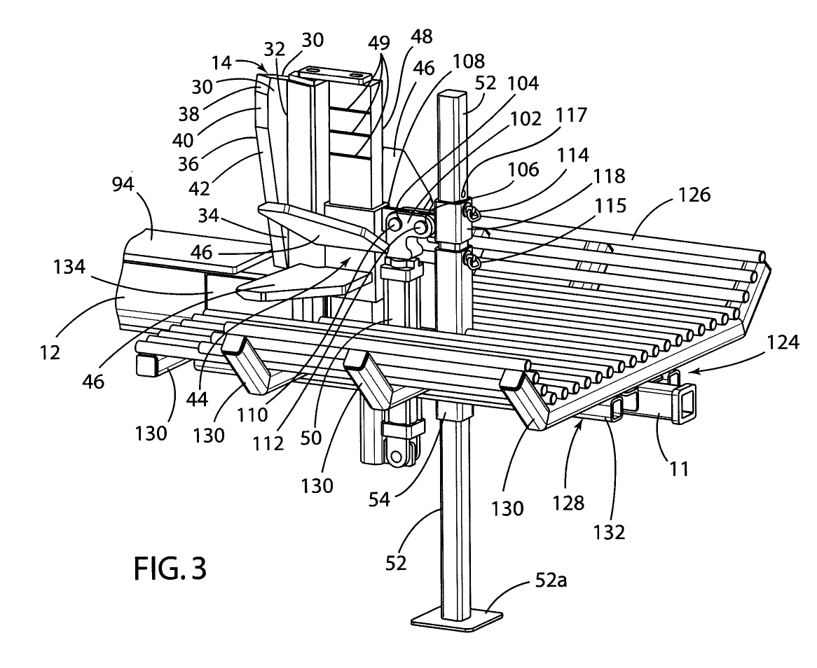

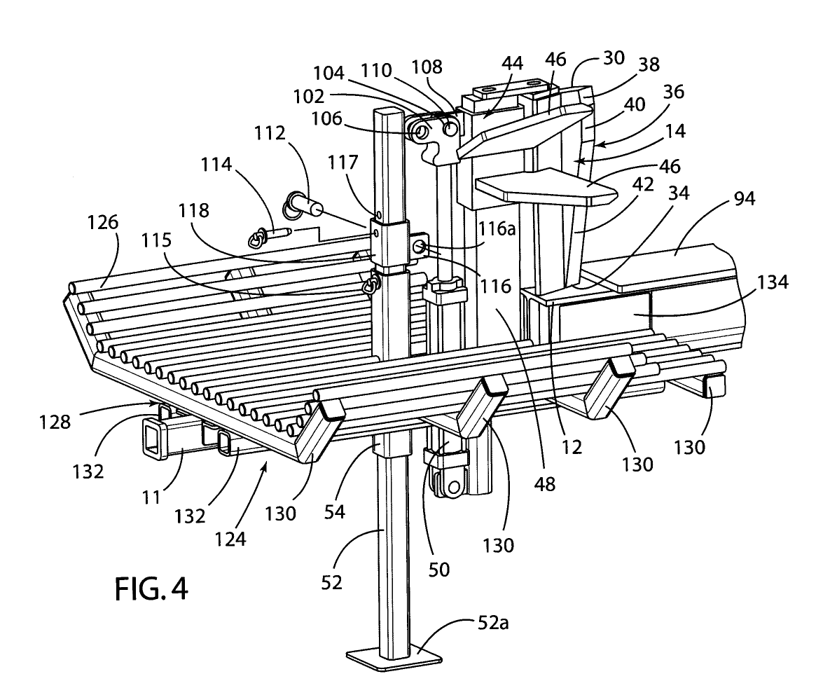

Turning first to one aspect of the invention, the wedge 14 is oriented vertically and is configured to open or split the workpiece starting from the top 30 of the wedge 14 and incrementally splitting the workpiece in the vertical direction. As illustrated in FIG. 2, the bottom of the wedge 34 is secured to the elongated member 12. A tie plate 122 secures the top 30 of the wedge 14 to a post 48 for additional support. The post 48 is connected to the elongated member 12 through the cradle portion 124 of the apparatus 10. The cradle portion 124 includes a plurality of elongated members, illustrated as tubular members 126, supported by a frame, seen generally at 128, formed of cross 130 and longitudinal 132 support members. As illustrated in FIGS. 2-4 a plate number 134 helps attach and secure the cradle portion 124 to one end of the elongated member 12 adjacent the wedge 14. It should be understood, that the cradle portion 124 is operative to provide a platform for and receive the workpiece after being split.

The wedge 10 has a multi-angled or multi-arcuate cutting edge 36. Further, as illustrated, the wedge 14 extends farther outward at the top portion 30, that is closer to the log pusher 20, than it does at the lower portion 34 of the wedge 14. Accordingly, the cutting edge 36 of the wedge 14 gradually tapers or angles back from the top 30 to the bottom of the wedge 14. In addition, the wedge 14 includes an upper section 38, middle section 40 and lower section 42. The upper section 38 having a cutting edge that is angled or tapered rearward, towards the post 48. The middle section 40 having a cutting edge positioned generally vertical or transverse to the longitudinal axis of the workpiece forced against the wedge 14 and the lower section 42 having a taper or angle extending from the middle section 40 rearwardly to the bottom of the lower section 42. Accordingly, when viewing the wedge 14 vertically it has an angled, rearwardly tapered upper section 38 and has an angled, rearwardly tapered lower section 42. Accordingly, the angled, rearwardly tapered lower section operates to guide the workpiece downward against the wear plate 94.

As illustrated, a secondary wedge, seen generally at 44, having a plurality of wedge members 46 used to further split the workpiece. The secondary wedge 44 is movably secured to the post 48. A hydraulic cylinder 50 is attached on one end to the frame 128 of the cradle portion 124 and on the opposite end to a clevis 102 having apertures or openings 104, 106. The hydraulic cylinder 50 operates to position the secondary wedge 44 at various positions along the post 48, indicated by indicia lines 49, whereby the secondary wedge 44 is positioned depending upon the size of the workpiece. Specifically, the secondary wedge 44 includes an ear 108 having an opening sized to receive a pin 110 extending through the opening 104 in the clevis 102 and the opening in the ear 108. As indicated previously the hydraulic cylinder 50 receives hydraulic pressure from the hydraulic pump wherein when the pin 110 couples the clevis 102 to the ear 108. Actuation of the hydraulic cylinder 50 moves the secondary wedge 44 along the post 48. Thus, the operator can position the secondary wedge 44 at any one of the discrete positions shown by the indicia lines 49 on the post 48 or may select any alternative position as needed.

The hydraulic cylinder 50 also performs a second function in that it is used to adjust the position of the front support or leg member 52. Specifically, the apparatus 10 includes a front mounted retractable type front support or leg member 52. The front mounted support 52 can be selectively positioned whereby the footpad 52a thereof engages the ground surface to level the front end of the apparatus 10. As shown, the hydraulic cylinder 50 used to position the secondary wedge 44 is also used to raise and lower the front support or leg member 52. As illustrated, the clevis 102 attached to the end of the hydraulic cylinder 50 has an additional opening 106. As set forth previously, when a pin 110 is placed through the opening 104 of the clevis 102 and the opening in the ear 108 of the secondary wedge 44 the hydraulic cylinder 50 is coupled to the secondary wedge 44. However, when a pin 112 is placed through the opening 106 of the clevis 102, and through an opening 116a in an ear 116 located on a sliding collar 118 disposed over the leg member 52 the sliding collar 118 is connected to the hydraulic cylinder 50. As illustrated, the leg member 52 slides or moves reciprocally in a support member 54. Once the leg member 52 is properly positioned, a locking pin 115 functions to secure the leg member 52 to the support member 54. In order to position the leg member 52, a pin 114 extending through the sliding collar 118 secures the sliding collar 118 to the leg member 52. The leg member 52 includes a plurality of adjustment openings extending along the longitudinal axis of the leg member 52 whereby the sliding collar 118 can be positioned at various locations along the length member 52. Accordingly, when the pin 114 extends through the sliding collar 118 and one of the apertures 117 in the leg member 52, the sliding collar 118 is secured to the leg member 52. Once the sliding collar 118 is secured to the leg member 52, the pin 114 extends through the opening 106 in the clevis 102 and the corresponding opening 116a in the ear portion 116 of the sliding collar 118 to couple the clevis 102 and correspondingly the hydraulic cylinder 50 to the leg member 52. Once coupled, the pin 115 can be removed whereby the leg member 52 may slide in the support 54. Thus, movement of the hydraulic cylinder 50 moves the leg member 52. It should be understood that once the leg member 52 is properly positioned, the pin 115 is once again inserted through the support 54 and an opening 117 in the leg member 52 to properly secure the leg member 52 to the support 54.

Once the leg member 52 is properly secured, the pin 112 can be removed whereby the clevis 102 is detached from the sliding collar 118 and the hydraulic cylinder 50 functions to properly position the secondary wedge 44. Accordingly, this arrangement provides the operator, by placing the pin 112 through the opening 106 in the clevis 102 thereby coupling the hydraulic cylinder 50 to the front leg member 52, with control over the movement of the leg member 52 from the top side of the apparatus 10. Using the same hydraulic cylinder 52 to adjust or position both the leg member 52 and the secondary wedge 44 eliminates additional components and correspondingly costs.

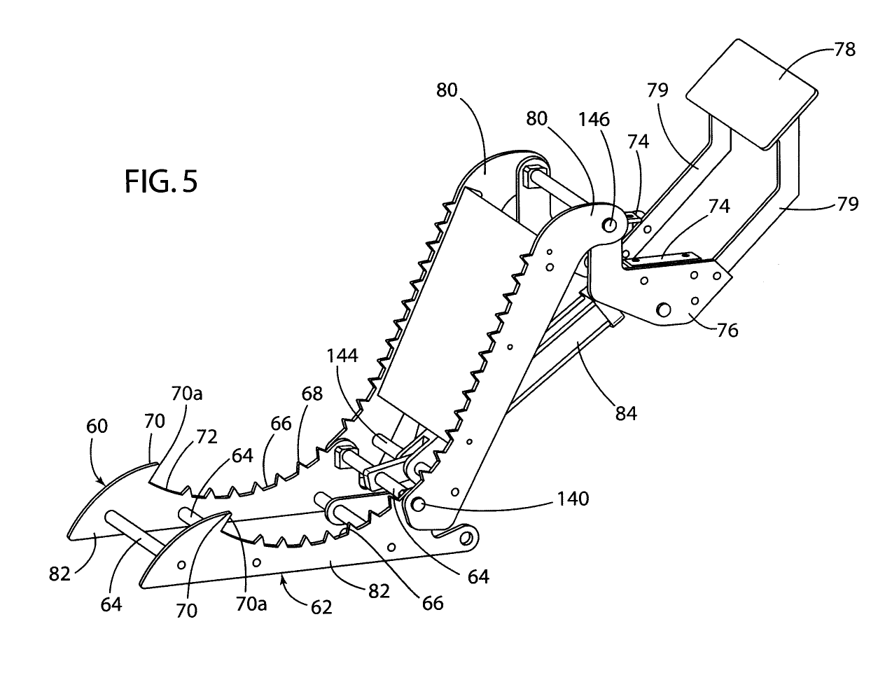

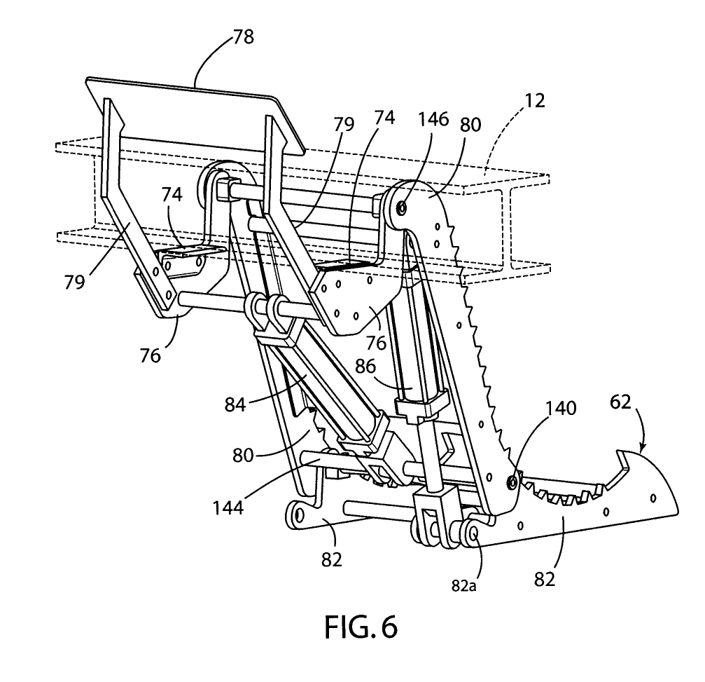

The apparatus 10 according to the present invention further includes a lift mechanism, seen generally at 60, used to pick the workpiece up off the ground and transfer it to the log carriage area 120. For the sake of illustration, an embodiment of the lift mechanism is shown in FIGS. 5-7 removed from the wood splitting apparatus 10. As set forth previously, the lift mechanism 60 is connected to the elongated member 12, shown in phantom in FIGS. 5-7. The lift mechanism 60 is attached through the mounting brackets 74 attached to the support brackets 76. The support brackets 76 and corresponding mounting brackets 74 are attached to the underside of the elongated member 12. A backing plate 78 is attached, via frame members 79 to the support brackets 76 opposite the upright section 80 of the lift mechanism 60. The backing plate 78 functions to guide and keep the workpiece or workpiece in the log carriage area 120 during the splitting operation; i.e. the backing plate 78 helps to prevent the workpiece from rolling out of the log carriage area 120 when deposited in the log carriage area 120 by the lift mechanism 60.

As illustrated the lift mechanism 60 may use a pair of single, non-hinged lift arms 62, see FIG. 1, or a pair of multiple section lift arms 62, see FIGS. 5-7 illustrating each of the lift arms 62 having two pivotally connected portions 80, 82. In both cases, the arms 62 can be formed from a flat material such as steel and connecting together with pipe, tube, bar or any other adequate connecting members 64. Each of the lift arms 62 have contoured or curved upper or contact surfaces 66 so that the upper surface 66 of the arm 62 that come in contact with the workpiece has a contour or curvature similar to the curvature of a workpiece. That is, rather than extend in a flat horizontal manner; the upper surface 66 of the arm 62 is curved so that it functions as a cradle to support the workpiece. In addition, the curved upper surfaces 66 include serrations 68 that help grip the workpieces. The serrated and curved design of the lift arms 62 provides for increased surface area to contact and hold the workpiece even when the lift mechanism 60 is not horizontal or the workpiece is frozen and would be apt to slide on the upper surface 66 of the lift arms 62. To help retain the workpiece once it is rolled onto the lift mechanism 60 the lift arms 62 have a hook 70 with a rearward facing barb 70a located at the front of the lift arms 62. Accordingly, as the workpiece is rolled up over the hook 70 it rolls past the barb 70a and into the curved upper surface 66. If the workpiece rolls back towards the hook 70 it is stopped by the barb 70a. Once the workpiece is in the curved portion 67 or cradle the serrations 68 on the lift arms 62 help the lift mechanism 60 to grip and hold the workpiece better.

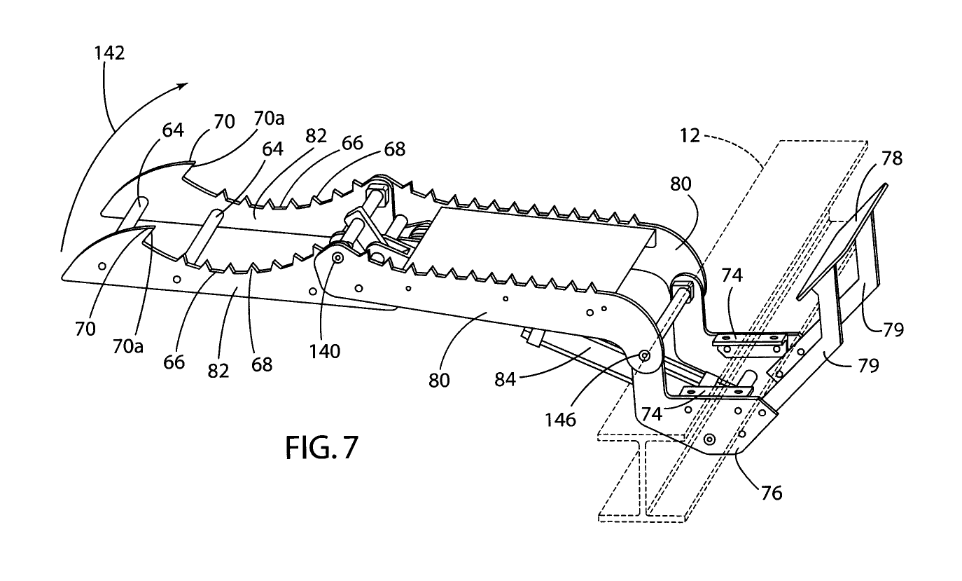

FIG. 1 illustrates a lift mechanism 60 having a pair of lift arms 62 each having an L-shaped design. FIGS. 5-7 illustrate an alternative embodiment of a lift mechanism 60 wherein each of the lift arms 62 are formed of two portions, an upright section 80 pivotally connected to a base section 82. As illustrated in FIG. 7 a pivotal connection 140 between the upright section 80 and the base section 82 enables the lift mechanism 62 to extend outwardly in a horizontal position wherein the base section 82 and upright section 80 are in the same plane. Further, the base section 82 of the lift mechanism 60 rotates in the direction shown by the arrow 142 whereby it functions to push or feed a workpiece into the log carriage area 120. As illustrated, a plurality of hydraulic cylinders 84, 86 actuate the base section 82 and upright section 80 of the lift mechanism 60. The hydraulic cylinders 84, 86 are connected via hydraulic lines to the hydraulic pump operated or powered by engine 26 and are correspondingly controlled by the actuation levers 28. As illustrated in FIGS. 5-7, actuation of the hydraulic cylinder 86 coupled to the upright section 80 on one end and to an arm 82a located on the base section 80 on the opposite end causes the base section 82 to pivot with respect to the upright section 80 about the pivot pin 140. Hydraulic cylinder 84 is attached to the support brackets 76 on one end thereof and to a cross member 144 connecting the respective upright sections 80. Accordingly, actuation of the hydraulic cylinder 84 causes the lift mechanism 62 to pivot about pivot pin or connection 146. Accordingly, the lift mechanism 60, having a pivotally connected base section 82 and upright section 80 independently actuated by the hydraulic cylinders 84, 86, can be placed in a multitude of positions to lift, hold and load the wood splitting apparatus. In addition, as illustrated in FIG. 7, the lift mechanism 60 is frequently used in a raised or semi raised position for stacking and holding a workpiece of the prior to the splitting operation.

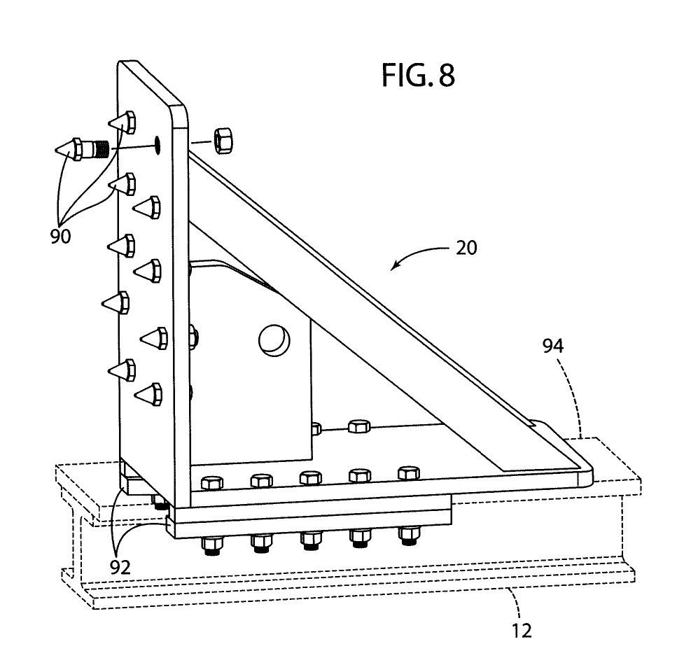

Turning to FIG. 8 the log pusher 20 is shown in greater detail. One feature of the invention is that the log pusher 20 includes removable and replaceable log points 90. These points are inserted into the face of the log pusher and help to secure and maintain contact between the log pusher 20 and a workpiece located in the log carriage area 120

As the points 90 wear, they can be easily removed and replaced. In use, when the log pusher 20 meets the workpiece, the log points 90 push into the workpiece, which increases the area of contact between the log pusher 20 and the workpiece, whereby the workpiece points 90 grip the workpiece and keep the workpiece from sliding up, out or sideways in the log carriage area 120 during the splitting process.

In addition, the log pusher includes a pair of gibs 92 used to secure the log pusher 20 for longitudinal movement to a precisely sized, durable steel wear plate 94, see FIG. 1, attached to the elongated member of 12. The wear plate 94 adds structural integrity to the elongated member 12 and correspondingly to the frame 24 of the apparatus 10 and provides a consistently sized support member on which the gibs 92 and correspondingly the log pusher 20 travel. Using the wear plate 94 provides an accurately sized guide member on which log pusher 20 travels thereby reducing stress and wear on the elongated member 12.

Turning to a further feature of the invention, operation of the lift mechanism 60 causes the weight of the workpiece to be absorbed by the tire 22 on the lift mechanism 60 side of the wood splitting apparatus 10. Heavier workpieces will collapse this tire 22 and over time ruin it. Further, the weight of the workpiece tends to tilt the log splitter 10 to one side. Depending upon the stability of the tire and ground, when using the lift mechanism 62 to lift a heavy workpiece the operator may transfer the workpiece too quickly from the lift mechanism 60 to the log carriage area 120, as set forth above the area adjacent the wear plate 94 and between the log pusher 20 and wedge 14, doing so may cause the workpiece to roll into the log carriage area 120 fast enough to roll over the support plate 78 and out the opposite side.

To provide additional support to the wood splitting apparatus 10, of the present invention incorporates an additional support leg 100, see FIG. 1, positioned adjacent the lift mechanism 60. The support leg 100 is slidably disposed in a collar 101 and is secured in place by a pin 103. Accordingly, the support leg 100 absorbs the weight of the workpiece as it is being transferred from the ground to the log carriage area 120. It should be understood that the support leg 100, may be moved up and down and positioned hydraulically as set forth above. Further, the support leg 100 may be mounted on an extendable arm that moves outward in an outrigger fashion to provide additional support. In addition, while only one support leg 100 is shown, it is within the scope of the present invention to add an additional support leg to further transfer the load from the lift mechanism 60 during operation thereof.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A wood splitting apparatus comprising:
a frame;
a wedge supported on said frame;
a drive mechanism supported on said frame; and a lift mechanism attached to said frame.
